(19) United States
(12) Patent Application Publication
(10) Pub. No.: US 2014/0181303 A1
(43) Pub. Date: Jun. 26, 2014

(54) CUSTOM LOCAL CONTENT PROVISION

(71) Applicant: Scott Andrew Meyer, Hixson, TN (US)

(72) Inventor: Scott Andrew Meyer, Hixson, TN (US)

(21) Appl. No.: 13/725,025

(22) Filed: Dec. 21, 2012

(51) Int. Cl. H04W 8/18

(52) U.S. Cl. CPC H04W 8/18
USPC 709/225

(57) ABSTRACT

A system and method are described through which a user may wirelessly access custom local content from a local hosting server which incorporates a content management system (CMS) to facilitate administrator-level access and user-level access to the custom local content.

### BACKGROUND OF THE INVENTION

The present invention relates to systems for providing information content, and more particularly, to providing customized content to a targeted local audience.

It is known in the art to provide local copies of content synchronized with primary content available at another location. For example, as illustrated in FIG. 1, edge servers or caching proxy servers may be located physically or electronically nearer a user accessing served data than the central servers that primarily provide the data. Such systems may be used to improve overall network bandwidth and latency to distant users, and may reduce the demand load on central servers.

In contrast, there may sometimes be a need to deliver specific custom content to a local audience, without dependency upon central servers or a wide-area network (WAN) connection. There may also be a need to deliver specific custom content to a local audience without the clutter and disruption that may be introduced by a “one size fits all” internet web page presentation, for example. Even today with the proliferation of smart phone, tablet, and other small-format displays, much internet content remains optimized for viewing on a larger display screen.

An object of the invention is to meet one or more of these needs, preferably through a wireless local communication system for providing custom content to a local audience.

### BRIEF SUMMARY OF THE INVENTION

In a basic embodiment of the invention, software (which may include a content management system or “CMS”) is resident on hardware (which may include a wireless access point), and provides a custom website or data page to a local audience.

In this context, a “CMS” is software that provides a framework for developing or maintaining a website. For example, a site manager who has little or no web programming experience could potentially use a CMS to build or maintain a robust website that presents itself as professionally designed. In a preferred embodiment, a CMS is provided which employs an adaptive web design methodology to arrange visual elements of a web site's content in a framework which allows for automatic adjustment or rearrangement to optimize or improve content presentation for various user platforms, taking into account, e.g., a user device's screen size, memory, connection speed, etc.

### DRAWINGS REFLECTING SOME PRINCIPLES & EMBODIMENTS

The invention may be be better understood with reference to the following figures and detailed description.

FIG. 1 illustrates a WAN configuration in which a cloud includes both central servers and edge servers or caching proxy servers located physically or electronically nearer a user accessing served data.

FIG. 2 is a block diagram illustrating a layout of a custom content provision system according to an embodiment of the invention.

FIG. 3 is a flowchart illustrating steps according to a custom content provision method embodying the invention.

FIG. 4 illustrates a typical hardware configuration of a server, including wireless networking capabilities and optional peripheral connections.

FIG. 5 illustrates in greater detail some of the custom site content depicted in FIG. 2.

### DETAILED DESCRIPTION

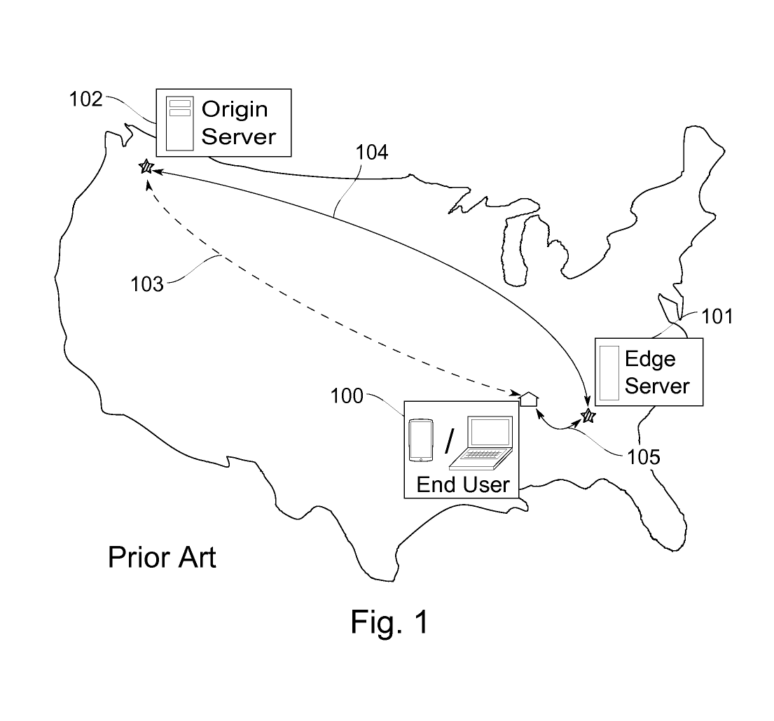

A known WAN configuration is depicted in FIG. 1, where broadly available content originates on a remotely situated origin server 102. When such content is requested by an end user device 100, the system determines that the content is already available at an edge server 101 which is typically located nearer (in both geographical and electronic proximity) to end user 100 than the distance between origin server 102 and end user 100. Via various update paths 104, origin server 102 refreshes its content on various distributed edge servers 101. So long as the distance 105 between end user 100 and edge server 101 is shorter than the distance 103 between end user 100 and origin server 102, the system can function efficiently by delivering requested content with reduced network latency and reduced burden on origin server 102. Such systems, however, are best adapted to circumstances in which “one size fits all” content needs to be distributed over a broad network coverage area.

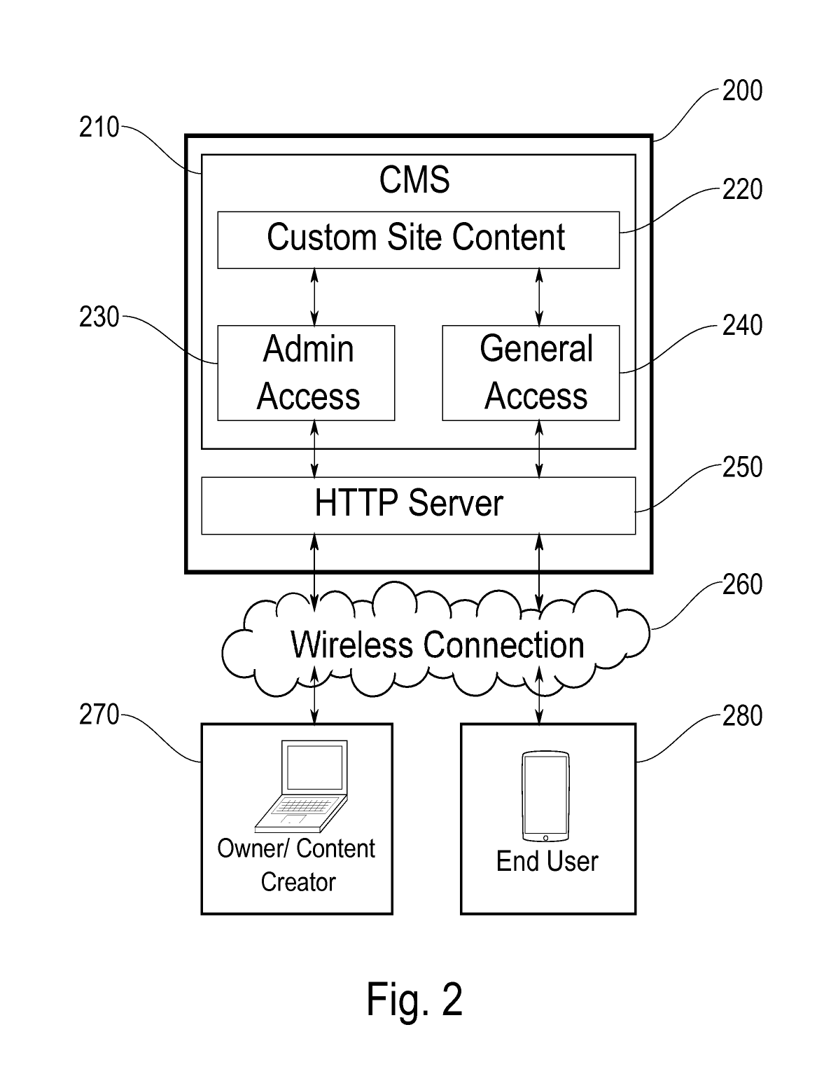

Some principles according to a custom content provision system embodiment of the invention are illustrated in FIG. 2. Conceptually, a hosting device or server 200 houses hardware and software comprising HTTP server interface 250 and a CMS 210. The CMS 210 further comprises certain custom site content 220, and access interfaces 230, 240, which facilitate access by administrators and by the general user population, respectively. Via at least a wireless connectivity interface 260, users 270, 280 may interact with server 200. Specifically, owners, administrators, or content creators 270 can connect through wireless interface 260 over HTTP server 250 through administrator access channel 230 to review or modify content 220, facilitated by CMS 210. Additionally, general end users 280 can connect through wireless interface 260 over HTTP server 250 through general access channel 240 to request and retrieve content 220, facilitated by CMS 210.

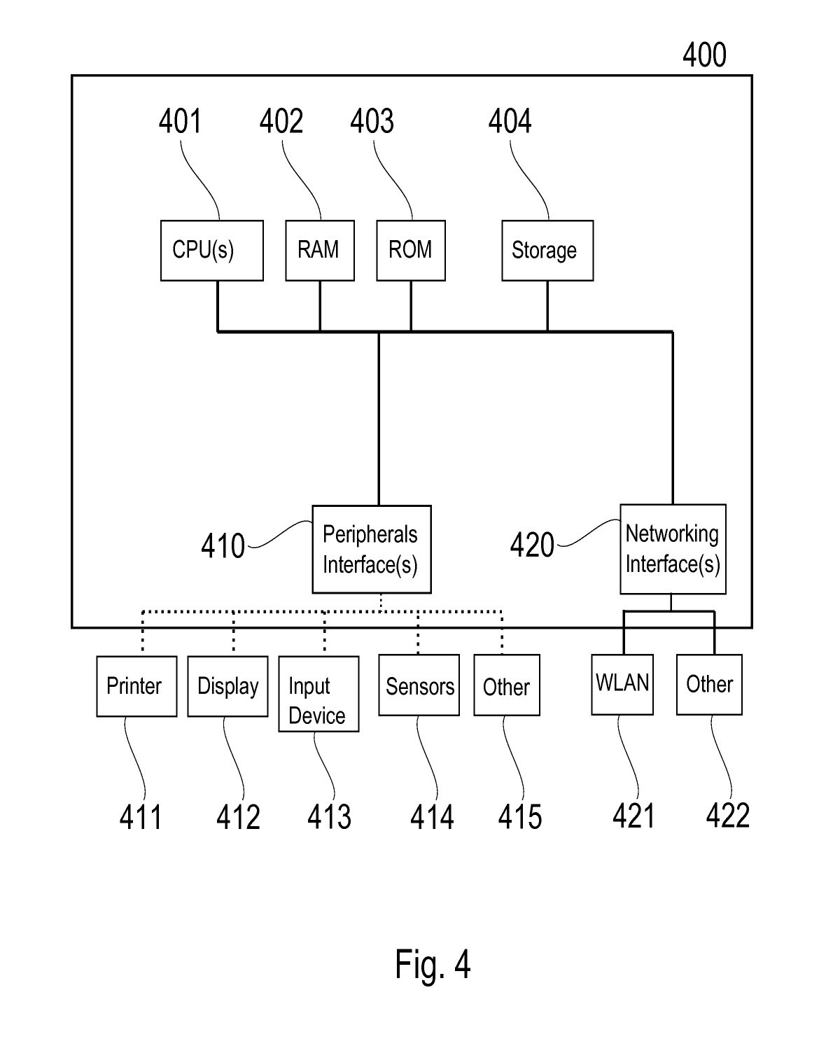

Principles of a system embodiment are further illustrated in FIG. 4, a more hardware-oriented depiction than the conceptual depiction of FIG. 2. In FIG. 4, server 400 (analogous to conceptually shown server 200 in FIG. 2) comprises a processor 401, dynamic memory 402, static memory 403, mass storage 404, at least one network interface 420, and perhaps peripheral interfaces 410. Resident on server 400, and specifically resident in storage 404 and/or ROM 403 and executed through RAM 402 using processor 401, is software comprising an operating system, server software, support software (e.g., interpreters, drivers, database), and a CMS. The boundary between the CMS and other elements of the software may be fluid and not clearly defined. Additionally, custom content resides in storage 404.

Optional peripheral interfaces 410 may facilitate communication with various peripheral devices, e.g., a printer 411, display devices 412, input devices 413, sensors 414, or other peripherals 415. Network interface 420 provides for bi-directional communication with any suitable content owner device or with any suitable user device. Network interface 420 preferably comprises a wireless connection point allowing for bi-directional communication in at least one wireless communication protocol, e.g., 802.11 Wi-Fi in a Wireless Local Area Network (WLAN) 421. However, a network interface 420 may provide other modes of connectivity 422 in addition to or instead of Wi-Fi communication—for example, hardwired, infrared, bluetooth, near-field communications, cellular phone networking, etc.

To illustrate system functionality according to an embodiment, again with reference to FIG. 2, user 280 may come into proximity of hosting server 200. Perhaps signage, literature, audio, video, or some other means advertises to user 280 that custom content in some way relevant to the physical location of user 280 is locally available from server 200. User 280 may initiate communication with server 200 with a suitable user device, e.g., a smart phone. Communication is achieved through wireless connection 260 across HTTP server 250 through general access interface 240. In response to contact or request by user 280, server 200 through CMS 210 provides custom content 220 to the device of user 280. For example, a visitor to a United States national park might see a sign to the effect “Check here to download weather conditions and trail maps via Wi-Fi.” She might use her phone or tablet device to connect wirelessly and download any such desired custom content.

Initially, or periodically, a content owner or manager 270 may set up, update, or modify custom content 220 through a suitable owner device. This could be a keyboard, a laptop, a wireless device such a smart phone or tablet, or some other means for connecting to the hosting device 200. Communication is achieved through wireless connection 260 across HTTP server 250 through administrator access interface 230, and CMS 210 allows manager 270 to readily set up, update, or modify custom content 220 as needed. For example, a park ranger might use such a system to modify local trail maps to show a temporary closure of a certain park area.

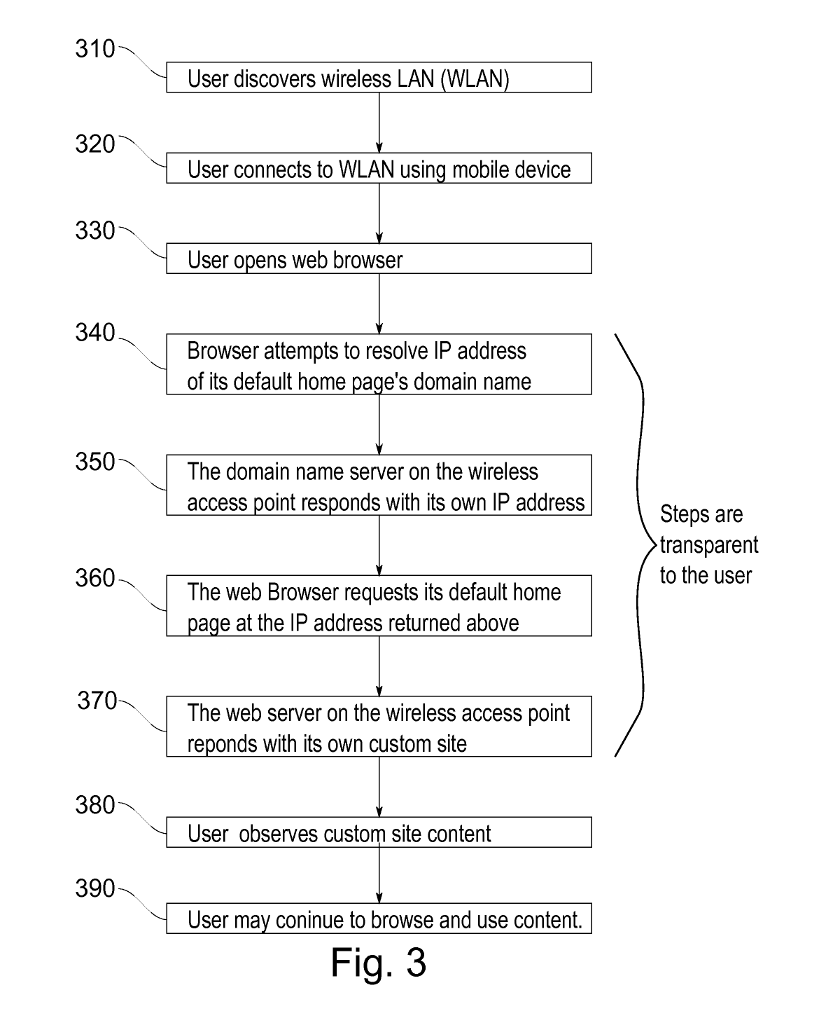

Some principles according to a custom content provision method embodiment, illustrated in FIG. 3, are similar. A user discovers that custom content is available to be locally provided, step 310, and initiates a connection in step 320. User may open a web browser in step 330, triggering a sequence of processing steps 340, 350, 360, 370, which are generally invisible to the user. In step 340, user's browser attempts to resolve an IP address of its default home page's host name. In step 350, the domain name server on the wireless access point responds to the browser by providing its own IP address. At step 360, the browser requests its default home page at the IP address which has been returned. In step 370, the server on the wireless access point responds by providing its own custom site. Then in steps 380 and 390, respectively, user may observe the custom site content now displayed on user's browser, and may continue to use, browse, and access information related to the custom site content.

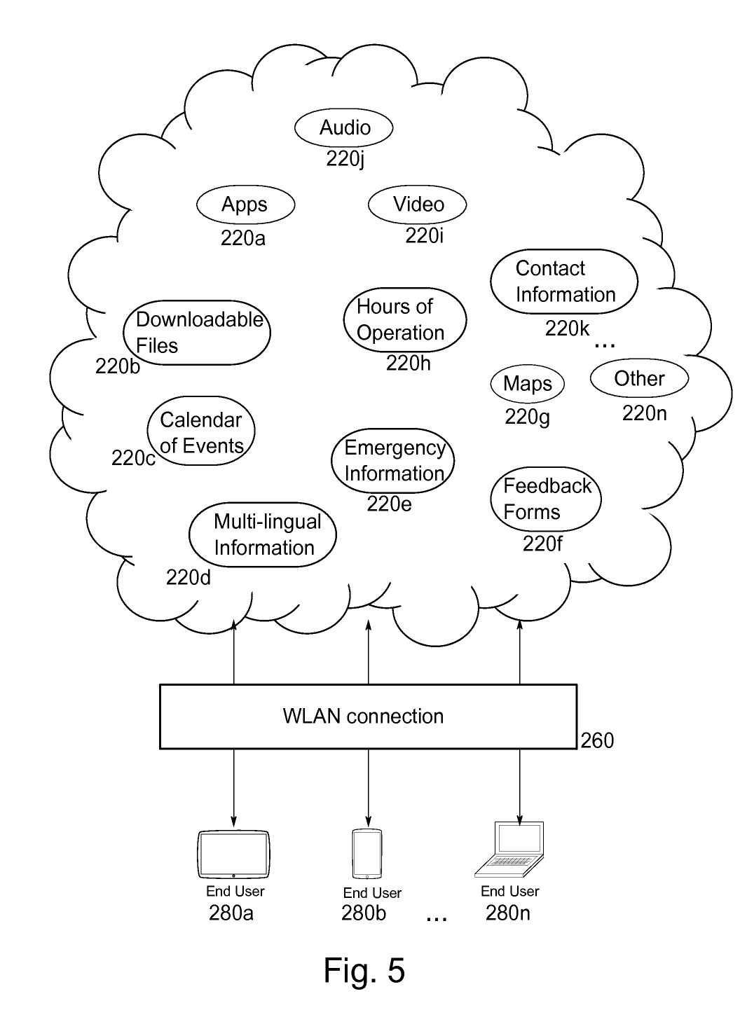

Illustratively in FIG. 5, elaborating on aspects shown in FIG. 2, various end user devices 280a, 280b, . . . 280n can be used across WLAN connection 260 to access a variety of forms of custom local content 220, such as software applications (“apps”) 220a, downloadable files 220b, etc.

A website on the Internet may be typically designed to provide all the information users may appear likely to want. This is potentially a large amount of information, broad in scope. In order to make such information accessible, large and often complex websites may be built, and may be primarily designed for display on devices with relatively large screens such as a desktop or laptop computer.

In comparison, a typical user of the present invention may want specific information that is narrower in scope, and likely will be using a mobile device such as a smart phone or tablet. The desired information may indeed already be available on the Internet, as prior disclosures assume. However, the information may not be available in such form, and a completely local solution in accordance with the invention may be necessary. Even when similar or duplicate information is available on the Internet, the invention provides a system and method for accessing such information without dependency on distant central servers or a WAN.

Moreover, even if an existing Internet web page contains desired specific information, it may often be mixed with irrelevant information beyond the desired scope and may be sub-optimally formatted for focused display on a relatively small mobile device. Editing existing Internet web pages to modify for the needs described can often be an extensive and time-consuming effort. For example, removing extraneous information, repairing or removing broken links, optimizing display layout, disabling any features incompatible with the target delivery device, etc., could be a difficult process to repeat many times for many users attempting to access a variety of content.

The present invention addresses problems of availability, content, and presentation by providing for a custom-designed local website. Availability issues are generally resolved, because an existing Internet website is no longer a necessary source for the local site. The scope of content problem is generally resolved, because a custom-designed local website will not inherit distracting or extraneous information, but will generally be designed for its specific purpose. The quality of presentation can be optimized or improved by employing web design techniques that support optimal or improved presentation across a range of client devices.

In general today, when a user starts a modern web browser it automatically opens a default page. Transparent to the user, the program connects to the Internet, resolves a domain name to an IP address, and requests information from a web server associated with that address. According to an aspect of the invention, a user instead will be automatically shown custom content hosted on the local device rather than making an attempt to connect to the Internet. The particular domain name assigned to the local server, or the corresponding URL displayed in the user's browser window, need not correspond, e.g., to the owner's presence on the world-wide web. If desired, a custom site can supply a bookmark for later access to related information hosted on the Internet, without any need to maintain absolute compatibility or synchronization between the access point and the Internet. By not attempting URL compatibility, according to a preferred embodiment, simplicity and ease of use for the content manager and the end user are preserved.

One of many possible illustrations of the utility of the invention is described with reference to a remote public parks destination—for example, a wilderness mountaintop destination with a privately-operated lodge offering hot meals and overnight accommodations to hikers. Being very remotely situated, the lodge lacks electrical grid power and even cellular telephone system access. Nevertheless, visiting hikers often bring their mobile devices such as smart phones, whether for potential emergency use, for GPS tracking capability, or simply out of habit.

Even at this remote and primitive destination, there is much information to which visitors would appreciate having access: emergency information, hours of operation at main office and dining room, dinner menu, maps of nearby trails, concise guides to local flora and fauna, etc. Some of this information is different from the sort of information which typically would be displayed on the lodge's primary Internet site, which is formatted for optimal use on a large screen and which focuses primarily on helping potential visitors make reservations and find the lodge.

A custom local wireless server according to the invention could provide the desired local content, and more. Visitors could access the desired locally-relevant content, and perhaps even be able to post information to the server: feedback to their hosts, recommendations to other guests, photos, videos, commentary, etc. This would be possible without substantial network infrastructure because all the data and software can be stored locally on the wireless server. The invention can even circumvent a need for electrical power infrastructure, because a local device within the scope of the invention can be capable of operating on such modest power requirements that a battery, perhaps continually charged by a small solar energy panel, can supply the required level of power indefinitely.

It would even be possible to provide a custom application or “app” to users, such as a GPS-enabled mapping app packaged with high-quality topographical maps of the surrounding park, showing trails, places of interest, and the lodge. If a visitor became lost while exploring the area, a function of the app could show the most direct route back to the lodge, or the nearest accessible trail.

In such cases the invention would provide a number of advantages over the status quo. Currently most parks information is distributed in printed literature, brochures, maps, etc., which have a real per-unit production cost, produce paper waste, and are not always readily available when needed. Updating the paper-printed content is also time-consuming, costly, and wasteful. By contrast, a solar-powered local wireless server according to the invention would have an up-front purchase and implementation cost, followed by negligible costs for continual operation thereafter. It would also have a high level of on-demand availability, and produce no paper waste.

A further example demonstrating the utility of the invention is a music festival—an outdoor, multi-day event attracting large audiences and a variety of talented musicians. Some bands already have large and loyal fan bases, but many bands at such events are smaller, less well-known, and eager to expand their audiences. A typical music festival consists of multiple venues spread over a fairly wide local geographical area, with multiple concerts occurring simultaneously at different sites. Scheduling information can be complex. People attending a music festival typically depend on a printed guide for information about artists and the times and locations of their performances.

A local network of wireless servers deployed in accordance with the invention could provide all the information typically contained in a printed guide, but organized in a much more useful and intuitively accessible manner. If wireless servers are deployed at specific intervals throughout the festival grounds, users could access “you are here” features including maps, schedules, lists of performers, and other relevant information. Unlike a printed guide which can only provide limited information about each performer because of space constraints, the wireless servers can provide more in-depth quality and quantity of content on demand—even audio or video samples of the band's music. A user interested in a particular band could select an option to display a custom map showing the approximate route to the next available performance, and an estimate of the required walking time.

Individual bands could maintain their own personalized wireless servers and make them accessible to fans attending their shows. These could provide specific information about a band, such as future tour dates, albums, and merchandise. Bands could reward fans for attending their shows by providing unique downloadable content—audio clips from the actual concert, downloads of other selected tracks, etc. If desired, access to content could be restricted by selling tickets with one-time-use access codes.

Once again, the general-purpose Internet website content relating to a music festival tends to be not formatted or customized to the needs of those actually in attendance at the event. The festivals themselves are typically held in large outdoor venues such as fields or parks, lacking permanent electrical power or information network infrastructure. Wireless local content servers deployed in accordance with the invention can be independent of pre-existing electrical or network infrastructure and can provide data transfer rates and availability superior to that available over a cellular phone network. Whereas conventional location-aware Internet services often require use of GPS satellites, and thus a significant drain on user device battery life, a set of wireless servers strategically deployed over a local area can provide location-specific information and services without requiring GPS access.

The music festival example also highlights the potential for the invention to serve as a powerful platform for limited-area deployment of exclusive content, and even instant deployment of new content. These functions cannot be duplicated through existing Internet channels of communication without potentially dampening local event attendance or cannibalizing sales.

In a further embodiment of the invention, a mesh network of local wireless servers can be deployed to achieve a multiplied effect. Instead of using only a single wireless server unit, a plurality of units can be distributed over a larger, but still local, geographic area. Such a mesh network could provide relative ease of administration, whereby an owner or administrator could update or upgrade all devices by accessing a single node. A mesh network could also allow for provision of distinct information on each node, depending on that unit's geographic situation. Information could be proximity-dependent so that the most relevant information is served to user devices in that immediate area.

Many modifications or expansions upon the invention and the various illustrative embodiments described herein still fall within the spirit and scope of the invention, and should be so considered.

The claimed invention is:

1. A system comprising:
a hosting server including a wireless interface and not dependent upon a WAN connection;
software resident in said server, said software comprising an HTTP server interface, a variety of custom local content, and a content management system;
an administrator device;
and a wireless user device;
said software configured to facilitate administrator-level communication between said administrator device, and said content management system and said content, via said HTTP service interface;
said software further configured to facilitate user-level communication between said user device, and said content management system and said content, via said HTTP server interface;
so that an administrator using said administrator device may access and modify said content;
and so that a user using said wireless user device may access said content.

2. A method comprising:
a user discovering availability of custom local content accessible from a custom site residing on a hosting server having a server IP address;
said user initiating a connection between a wireless user device and said server;
said user opening a web browser residing on said wireless user device;
said browser attempting to resolve an IP address associated with a default home page of said browser;
said server making a first response to said browser's attempt by providing said server IP address;
said browser requesting said default home page at said server IP address;
said server making a second response to said browser's request by providing said custom site;
said user using said wireless user device to access said custom local content on said custom site.
